(19) United States
(12) Patent Application Publication
(10) Pub. No.: US 2021/0008796 A1
(43) Pub. Date: Jan. 14, 2021

(54) ADDITIVE MANUFACTURING SYSTEM

(71) Applicant: HEWLETT-PACKARD DEVELOPMENT COMPANY, L.P., Houston, TX (US)

(72) Inventors: Juan Manuel ZAMORANO, Sant Cugat de Valles (ES); Albert TRENCHS MAGANA, Sant Cugat de Valles (ES); Luis Angel ORTEGA ESTORNEL, Sant Cugat de Valles (ES)

(73) Assignee: HEWLETT-PACKARD DEVELOPMENT COMPANY, L.P., Houston, TX (US)

(21) Appl. No.: 16/088,623

(22) PCT Filed: Apr. 24, 2017
(86) PCT No.: PCT/US2017/029070

§ 371 Date: Sep. 26, 2018

(51) Int. Cl. B29C 64/176; B29C 64/25; B29C 64/371; B29C 64/393

(52) U.S. Cl. CPC B29C 64/176; B29C 64/25; B33Y 10/00; B29C 64/393; B29C 64/371

(57) ABSTRACT

A method and system for causing an additive manufacturing system to print objects are described herein. A controller (110) of an additive manufacturing system (100) that comprises a build unit (120) and the controller (110) is arranged to receive print data defining an object to be printed by the additive manufacturing system (100). The controller (110) is arranged to cause the additive manufacturing system (100) to print a further object according to the modified print data, wherein the modified print data is determined on the basis of the print data.

### BACKGROUND

Some additive manufacturing systems generate three dimensional objects by forming layers of build material in a working area. In some cases, further printing agents such as fusing agents and detailing agents are also applied to the build material. Energy is then applied to a formed layer of build material to cause the build material to fuse where fusing agent was applied. This process is repeated layer-by-layer to generate an object according to a particular specification. Print data that specifies the shape of the object determines where the print agents are deposited in each layer. During printing and certain other heat-treatment processes such as curing and annealing, the build material is heated to temperatures above which it oxidizes. The effects of oxidation on the build material can be avoided by printing the object in an inert atmosphere.

### BRIEF DESCRIPTION OF THE DRAWINGS

Various features of the present disclosure will be apparent from the detailed description which follows, taken in conjunction with the accompanying drawings, which together illustrate, features of the present disclosure, and wherein:

FIG. 1 is a schematic diagram showing an additive manufacturing system according to an example;

FIG. 2A is a schematic diagram showing an additive manufacturing system according to an example;

FIG. 2B is a schematic diagram showing a post-processing container according to an example;

FIG. 3 is a schematic diagram showing an additive manufacturing system according to an example;

FIG. 4 is a schematic diagram showing a method of printing an object according to an example;

FIG. 5 is schematic diagram showing a method of generating print data according to an example;

FIG. 6 is a schematic diagram showing a method of printing a plurality of objects according to an example;

FIG. 7 is a schematic block diagram of a computer system according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples

Certain powdered build materials oxidize above specific temperature thresholds. A printing operation includes a pre-heating phase in which build material is heated before being processed in a print job, a printing phase where energy is applied to build material to cause the build material to fuse to form an object, and a post-processing phase. During a printing operation, the temperature of the build material and finished product can exceed thresholds above which the build material starts to oxidize. Oxidation can compromise the quality of the finished product. For example, oxidation can lead to finished products losing certain mechanical and cosmetic properties. Moreover the effects of oxidization pose a safety risk due to the risks of unsintered or unfused powder-based build material combusting.

One method of safely executing a print job is to print the object in an inert gas atmosphere. There is no potential for build material to oxidize in an inert atmosphere. However, it is also desirable to ensure that the build unit or the whole of the additive manufacturing system in which the print job is executed is gas-sealed such that the inert atmosphere is maintained. To retrieve the printed object the additive manufacturing system is accessed. Once the additive manufacturing system is accessed, the object is exposed to the ambient atmosphere, which is typically non-inert. Therefore, in certain cases the object remains in the additive manufacturing system until sufficient time has passed that the object has cooled down below a threshold temperature, at which the build material will not oxidize. This leads to reduced productivity.

A convenient way of addressing this issue is to provide a post-processing chamber that is coupled to the build unit, such that the inert atmosphere is preserved between the build unit and the post-processing chamber and where, after printing an object, the object is automatically moved to the post-processing chamber. This approach is not compatible with existing additive manufacturing systems, which do not couple to a post-processing chamber in a manner that maintains an inert atmosphere between the build unit and post-processing chamber.

In certain examples herein, a method of providing an inert atmosphere throughout a full printing process is described. In particular, the present methods and systems ensure that an inert atmosphere is maintained around an object before, during and after printing. Moreover, the method ensures that an inert atmosphere is maintained during a transfer between the additive manufacturing system and the post-processing system without modification to the additive manufacturing system. In cases where the build unit is removable from the additive manufacturing system, the build unit does not itself need to be sealed when it is removed from the additive manufacturing system. The method is compatible with existing additive manufacturing systems.

The present systems and methods dynamically determine a three dimensional enclosure for the object to be printed, based on the shape of the object. The three dimensional enclosure surrounds the object in its entirety, to form a gaseous seal. The enclosure is printed with the object, such that the inert atmosphere around the object is preserved within the enclosure. According to an example, the enclosure provides a gaseous seal around the object. In certain cases the enclosure is also printed to be readily breakable. This is achieved by, for example, printing an enclosure of a suitable thickness, such that the enclosure is both a gaseous seal and readily breakable. When the object and enclosure are transferred to a post-processing container, the object is recovered from within the enclosure by breaking open the enclosure.

The methods and systems described herein ensure that the inert atmosphere is maintained throughout the printing process and not just when the object is being printed. Using this method allows an object to be transferred as soon as a printing operation is complete rather than waiting for the object to cool below a threshold temperature. In particular, methods and systems described herein provide a way of guaranteeing an inert atmosphere around an object, without reducing productivity.

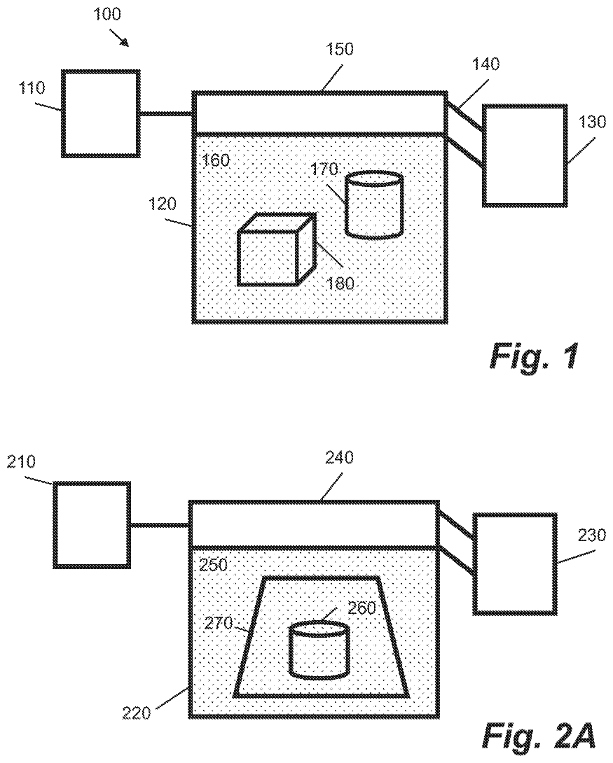

FIG. 1 is a simplified schematic diagram of an additive manufacturing system 100 according to an example. Certain examples described herein may be implemented on the additive manufacturing system 100. The additive manufacturing system 100 shown in FIG. 1 is used to print three dimensional (3D) objects. The additive manufacturing system 100 comprises a controller 110 and a build unit 120. The controller 110 is communicatively coupled to the build unit 120. In the example of the additive manufacturing system 100 shown in FIG. 1, the build unit 120 is coupled to a build material supply 130. The build unit 120 is supplied with build material from the build material supply 130 via a coupling 140. The build material is used to build 3D objects within the build unit 120.

In the example shown in FIG. 1, the build material supply 130 is detachably coupled via the coupling 140 to the build unit 120. In another example, the additive manufacturing system 100 is an all-in-one system where the build material supply 130 is integral to the build unit 120. In a further example, the build unit 120 is itself removable from the controller 110 and a housing (not shown in FIG. 1) of the additive manufacturing system 100. In the case that the build unit is removable from the additive manufacturing system, when the supply of build material in the build unit 120 is exhausted, the build unit 120 is moved to a powder station, where it can be refilled with build material, and is then recoupled to the additive manufacturing system 110, so that further printing operations can be executed.

In certain cases, the build material is in the form of a powdered material and comprises one or more of powdered metal materials, powdered composited materials, powder ceramic materials, powdered glass materials, powdered resin material, powdered polymer materials, and the like. According to examples described herein, a layer of build material is deposited on selected areas of a working area of the build unit 120. An energy source (not shown in FIG. 1) is applied to selected areas of the working area, where the build material is deposited. This causes the build material to coalesce to form a new layer on top of previously deposited layers on the working area. In this arrangement, an object is constructed in a layer-by-layer fashion by selective deposition of build material.

In FIG. 1, the build unit 120 comprises a printing head 150. The printing head 150 is arranged to move over the working area of the build unit 120 to execute a print operation by depositing build material and applying energy at selective locations. The printing head 150 is responsive to instructions received from the controller 110. In particular, according to examples described herein, the controller 110 is arranged to receive print data that defines the object or objects to be printed. According to an example, print data comprises instructions to deposit build material at selective locations of the working area to build the object. For example, print data comprises coordinates of the working area of the build unit 120 and instructions to apply energy to regions of the working area, to cause build material to coalesce at certain coordinates. According to examples herein, the energy source is in the form of an infrared or an ultraviolet light source. Energy is applied by the energy source for a variable amount of time and variable intensities, depending on the build material.

According to certain examples described herein, the print data received at the controller 110 comprises data corresponding to a plurality of objects. In such a case, the printing head 140 is arranged to deposit build material at at least two regions of the working area of the build unit 120, where the two regions are spatially separated from one another. In a further example, the additive manufacturing system 100 shown in FIG. 1 is arranged to print objects using different build materials. For example, it is possible to print a first object with a first build material and a second object with a second build material where each layer of the individual objects is composed of one build material.

According to examples described herein, the layer-by-layer synthesis of build material occurs in an inert atmosphere comprising an inert gas. This is represented in FIG. 1 by a shaded area 160, within the build unit 120. Accordingly, the build unit 120 shown in FIG. 1 is supplied with an inert gas. Examples of suitable inert gases for use with the additive manufacturing system 100 include argon or nitrogen gas. In one case, the build unit 110 is supplied with inert gas from an inert gas supply, which is coupled to the additive manufacturing system 100. In this setup the build unit 120 is supplied with a constant and/or controllable supply of inert gas. In another example, an operator controls a supply of inert gas independently of the additive manufacturing system 100, to fill the build unit 120 with inert gas.

According to an example, the build unit 120 is sealed during a print operation such that the atmosphere within the build unit 120 is maintained. This ensures that, no matter what temperature the build material reaches within the build unit 120, the build material is not exposed to potentially harmful effects of oxidation during a print operation. The build unit 120 is arranged to remain sealed until an operator of the additive manufacturing system 100 accesses the build unit 120 to remove contents from the build unit. This happens when, for example, an object is printed and an operator wishes to remove the object, subsequent to the printing operation. An operator may also wish to access the build unit 120 to remove excess build material in the working area of the build unit 120, for example, during a cleaning operation. In both cases, the build unit 120 can no longer maintain the inert atmosphere 160 and will be exposed to oxygen.

In the example shown in FIG. 1, two objects 170 and 180 are present in the build unit 120. Once the additive manufacturing system 100 has executed the print operations to print the objects 170 and 180, the objects are removed from the build unit 120. Further print operations can then be executed in the build unit 120. When an operator accesses the build unit 120 to remove objects 170 and 180, the inert gas atmosphere 160 inside the build unit 120 is no longer preserved. Consequently, the operator needs to wait until a sufficiently great period of time has passed, to allow objects 170 and 180 to cool below oxidation threshold temperatures, before exposing objects 170 and 180 to normal atmospheric conditions. In certain cases, for example, when the temperatures are very high or where the build material has a very slow cooling rate, there is along cooling period. In these cases, the operator of the additive manufacturing system 110 is unable to remove the objects 170 and 180 from the build unit without damaging the objects 170 and 180.

In certain examples described herein, the objects 170 and 180 are transferred from the build unit 120 to a post-processing container such that the objects 170 and 180 may cool in a controlled manner, to facilitate annealing and curing processes. In particular, the post-processing container also contains an inert atmosphere. It is also desirable to maintain an inert gas atmosphere during transfer of objects 170, 180 from the build unit 120 to the post-processing container to prevent oxidation.

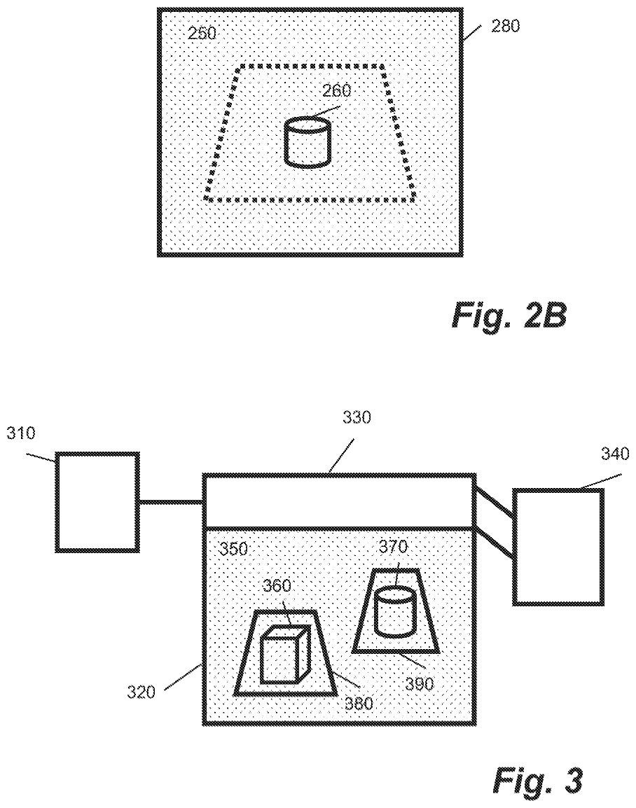

FIG. 2A is a simplified schematic diagram showing an additive manufacturing system 200 according to an example. Similarly to the additive manufacturing system 100 shown in FIG. 1, the additive manufacturing system 200 shown in FIG. 2A comprises a controller 210 communicatively coupled to a build unit 220. The build unit 220 is coupled to a build material supply 230, which is arranged to supply build material to the build unit 220. A print head 240 is arranged to move over a working area of the build unit, to deposit build material in a layer-by-layer fashion and apply energy to selective areas of the working area of the build unit 220. As in FIG. 1, the build unit is filled with an inert gas, such that print operations occur in an inert atmosphere 250. A printed object 260 (represented by the cylinder) is shown in the build unit 220 in FIG. 2A.

In the example shown in FIG. 2A, the controller 210 is arranged to receive print data that specifies instructions to print the object 260. According to an example, the print data is received at the controller 210 from an external computer (not shown in FIG. 2A). In other examples, the controller 210 is configured to receive print data from another source, such as computer code implemented within the additive manufacturing system 200. For example, in certain cases the additive manufacturing system 200 is configured to convert another kind of data such as data in a Computer Aided Design file that represents an object, to print data that is sent to the controller 210.

In the additive manufacturing system 200 shown in FIG. 2A, the controller 210 is arranged to cause the additive manufacturing system to print a further object 270 in the inert atmosphere 250. The further object 270 is printed according to the print data and modified print data that is generated on the basis of the print data. The modified print data is generated on the basis of the print data by dynamically processing the shape of a 3D enclosure on the basis of the shape of the object 260. In certain cases generating modified data on the basis of the print data comprises modifying the print data. In a further case, the modified print data comprises a new set of print data generated on the basis of the original print data, for example, generated as a copy of the original print data with additional data.

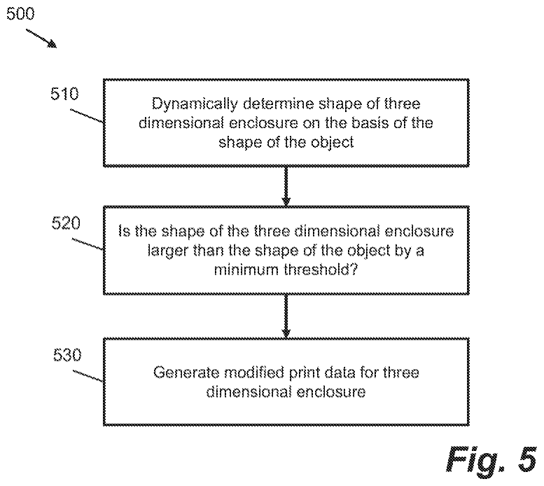

In one example, dynamic processing of the shape of the enclosure on the basis of the shape of the object 260 is executed by the controller 210 of the additive manufacturing system 200. The controller 210 is arranged to execute a process to determine the shape of the enclosure based on the received print data, which contains data that determines the shape of the object 260. In another example, a program on a computer that has access to the print data, which is external to the additive manufacturing system 200 executes a process to determine the shape on the enclosure. The methods of determining the shape of the enclosure are described below in relation to FIG. 5.

In the example shown in FIG. 2A, the further object 270 that is printed according to the print data and modified print data comprises an enclosure (represented by the trapezoid object in FIG. 2A) surrounding the object 260. The enclosure forms a gaseous seal around the object 260 that prevents the atmosphere from within the enclosure changing. In particular, when the further object 270 is printed in the inert atmosphere 250, the enclosure seals in the inert atmosphere 250 around the object 260. When the build unit 220 is exposed to oxygen, for example, when the build unit is accessed by an operator to retrieve the further object 270, the inert atmosphere is preserved around the object 260 that is inside the further object 270. This ensures that an operator can safely remove the object 260 from the build unit 220 without exposing the object 260 to oxygen.

FIG. 2B shows a simplified schematic diagram of a post-processing container 280, according to an example. Once the further object 270 is printed, the operator can remove it from the build unit 220 shown in FIG. 2A, and move it to the post-processing container 280, such that the object can safely be cooled without exposure to oxygen. This allows, for example, the operator to continue executing further print operations in the build unit 220, while the object 260 cools down in the post processing container 280.

According to an example, the further object 270 is breakable in such a way that the object 260 is left intact. One example method to print the further object 270 such that it is breakable is to print using a thickness of build material such that the resulting object 270 is readily breakable under an applied force but still sufficiently thick to seal the inner object 260. Once an inert atmosphere is established in the post-processing container 280, the operator can safely break into the further container to retrieve the object 260. Once a sufficient amount of time has passed and it is safe to expose the object to a natural gas atmosphere, the post processing container 280 is opened and the object 260 can be retrieved.

Examples of apparatus that can be utilized to break into the further object 270 while in the post processing container 280 include a robotic arm that is operated externally from the post-processing container 280. Alternatively a glovebox, comparable to those found in laboratories can be used as a post-processing container.

Alternatively, in a further example, the object 260 contained within the further object 270 can be cooled naturally without being placed in a post processing container. As long as the object 260 remains within the further object 270 that encases it, until sufficient time has passed that the object 260 has cooled to a sufficiently low temperature that exposing the object to an atmosphere containing oxygen does not lead to oxidization, the object 260 can be left to cool naturally.

FIG. 3 is a simplified schematic diagram showing an additive manufacturing system 300 comprising a controller 310, build unit 320, print head 330 and build material supply 340 similarly to the additive manufacturing systems 100 and 200 shown in FIGS. 1 and 2. Similarly to those systems, printing operations in the build unit 320 occur in an inert atmosphere 350. Two objects 360 and 370 are shown in FIG. 3.

In the example shown in FIG. 3, for each object 360, 370 the controller 310 is arranged to cause the additive manufacturing system 300 to print further objects 380 and 390. The further objects 380 and 390 are printed according to the print data corresponding to objects 360 and 370 respectively, and modified print data that is generated on the basis of the print data that corresponds to objects 360 and 370 respectively. The modified print data is generated by dynamically determining, for each of the objects 360 and 370, the shape of an enclosure surrounding the respective objects 360 and 370, on the basis of the shape of the respective object.

Similarly to the enclosure surrounding object 260 described in relation to FIGS. 2A and 2B, the enclosures in FIG. 3 surround the objects 360, 370 to form gaseous seals around them. The further objects, 380 and 390 comprise the objects 360 and 370, together with their respective enclosures. As with FIG. 2A, dynamically determining the shape of the enclosures is performed either by the controller, or externally, for example on a computer. If performed elsewhere, the controller is arranged to receive the generated modified print data. Otherwise, the controller is arranged to generate the modified print data itself.

By printing a plurality of enclosures for multiple objects, an operator can remove objects once the further object for that particular object has finished printing. For example, the operator can remove the object 380 in FIG. 3, if this finishes printing before the object 390 has finished printing. In contrast, in a case where a single enclosure is determined for a plurality of objects, objects are typically transferred to a post-processing container after all objects have finished being printed. This method may be desirable in a case where a large object is being printed with a small object, where a relatively large amount of time passes between the system completing the printing of the small object and the large object.

In other cases, it is more efficient to print a single enclosure that sealingly surrounds all the objects that are being printed on the working area of the build unit. For example, in a case where a large number of small objects are being printed, a single enclosure can be printed more efficiently than single enclosures for each object. In such a case, for example, the controller 310 dynamically determines the shape of the enclosure, taking into account that the received print data corresponds to the printing of more than one object. In some examples the controller 310 is arranged to compare the times for printing individual further objects for each object to be printed in the working area and compares these times to printing a single enclosure encompassing all the objects.

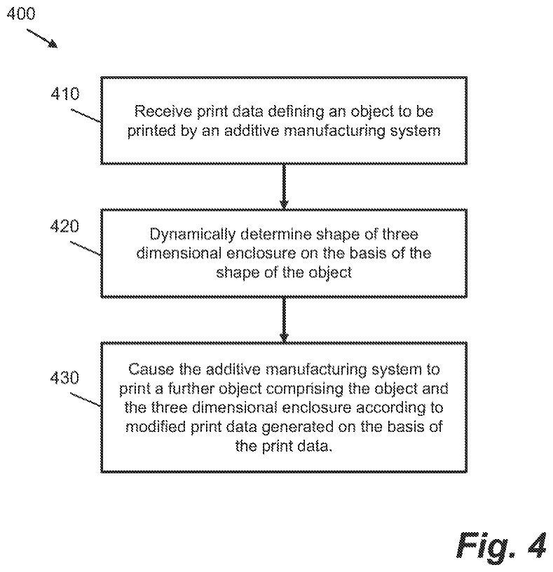

FIG. 4 is a block diagram showing a method 400 according to an example. The method 400 can be implemented on the additive manufacturing systems 100-300 shown in FIGS. 1 to 3. At block 410, print data is received that defines an object to be printed by an additive manufacturing system. In the context of implementing the method 400 on the systems 100-300 shown in FIGS. 1 to 3, the print data is received e.g. at the controller 110-310. At block 420, a shape of a three dimensional enclosure is dynamically determined on the basis of the shape of the object defined by the print data. The three dimensional enclosure forms a gaseous seal surrounding the object. Determining the shape of the three dimensional enclosure is implemented either by a controller or a computer in communication with the additive manufacturing system that implements the method 400. At block 430, a further object that comprises the object defined by the print data and the three dimensional enclosure, is printed according to the print data and modified print data generated on the basis of the print data.

According to examples of methods and systems described herein, the modified print data is either generated by the additive manufacturing system, or is received at the additive manufacturing system. In certain case, the method 400 is implemented on an additive manufacturing system that maintains an inert atmosphere in a build unit, such as those systems 100-300 shown in FIGS. 1-3. Moreover, in certain examples, the further object that is created by implementing the method 400 is a breakable object such that the object contained within the further object is left intact. According to an example, the resulting further object is larger than the object contained within the further object.

FIG. 5 is a block diagram showing a method 500 of generating print data according to an example. The method 500 can be implemented on the additive manufacturing systems 100-300 shown in FIGS. 1 to 3. At block 510, the shape of a three dimensional enclosure is determined on the basis of the shape of an object. This is implemented, for example, at the controllers 110-310 of the additive manufacturing systems 100-300. A shape of a three dimensional enclosure can be determined from the shape of an object by executing one or more processes on the print data that defines the object. For example, print data specifies, in certain cases, locations of where the print head is to be positioned to deposit build material to print the object.

In one example, an enclosure can be generated by expanding the locations specified in the print data that corresponds to the object, in an outward direction in all dimensions. The resulting enclosure is larger than the original object, however this may or may not be large enough for certain purposes. Other methods of determining enclosures are possible. For example, in one case, an enclosure can be defined that encompasses the whole outer surface of the printable volume of the additive manufacturing system. Such an enclosure is suitable in a case where an object to be printed encompasses a significant proportion of this volume.

At block 520, a determination of whether the shape of the three dimensional enclosure is larger than the shape of the object by a minimum threshold, is made. In one example, the determination is made by the controller of the additive manufacturing system that implements the method 500. In one case, the determination is made by comparing whether the locations that define the three dimensional enclosure are sufficiently far away from the locations that define the object, which are obtained from the print data. In certain cases, locations are defined in terms of “voxels”. A voxel is defined as a minimal printable three dimensional block of the additive manufacturing system. In certain examples, the minimum threshold is defined as at least one voxel in all dimensions.

At block 530, modified print data for the three dimensional enclosure is generated. As with the blocks 510 and 520, this is implemented at e.g. the controllers 110-310 of the additive manufacturing systems 100-300.

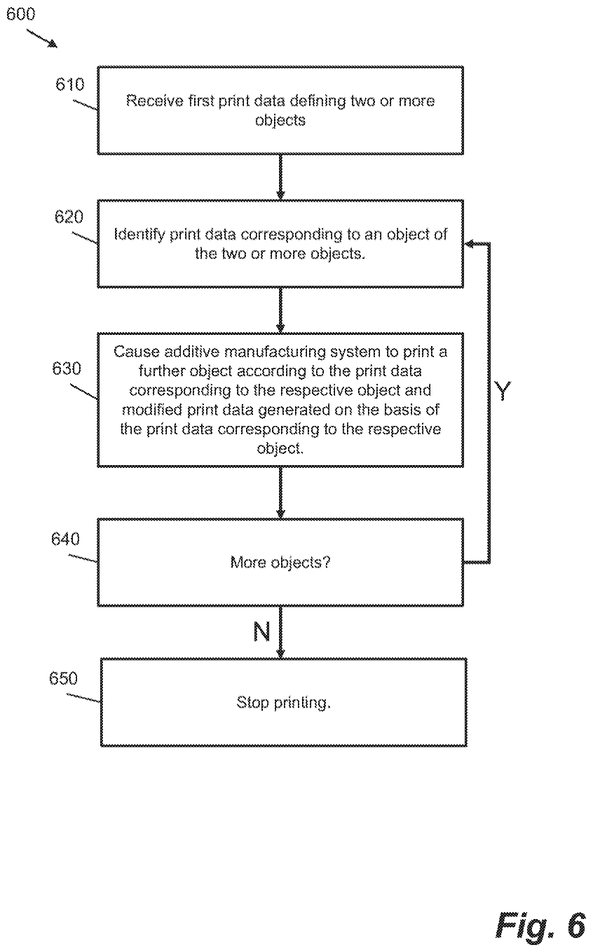

FIG. 6 is a block diagram showing a method 600, according to an example. The method 600 can be implemented on the additive manufacturing systems 100-300 shown in FIGS. 1 to 3. The method 600 shown in FIG. 6 is a method to print separate enclosures for a number of objects being printed on an additive manufacturing system.

At block 610 print data is received that defines two or more objects. At block 620, print data corresponding to one of the objects is identified from the print data. At block 630, the additive manufacturing system prints a further object according to the print data corresponding to the respective object and modified print data generated on the basis of the print data corresponding to the respective object. As previously described, the three dimensional enclosure forms a gaseous seal surrounding the respective object and the further object comprises the object and the three dimensional enclosure.

At block 640, a determination is made as to whether there are more objects defined by the print data. The determination is executed e.g. at the controller of the additive manufacturing system implementing the method 600. If it is determined that there are further objects defined by the print data, then the method 600 repeats the process of identifying print data corresponding to objects in the received print data and printing further objects for the respective objects identified in the print data. If it is determined that there are no more objects in the print data then, at block 650 the additive manufacturing system stops printing objects.

The methods and systems described herein provide a means for protecting objects printed on additive manufacturing systems from the potentially harmful effects of oxidation. In particular, certain methods and systems described herein allow objects to be transferred from a build unit of an additive manufacturing system, safely and efficiently to a post processing system, or to cool naturally, without exposing the object to the harmful effects of oxidization.

The present systems and methods ensure that objects are not exposed to an atmosphere with oxygen by determining a three dimensional enclosure for an object that is to be printed and by causing the additive manufacturing system to print a further object that forms a gaseous seal around the object. Thus, when the object is printed in an inert atmosphere within the build unit, the inert atmosphere is preserved around the object by the further object. The present methods can be implemented with any printing processes that use an inert atmosphere, where objects are synthesized in alayer-by-layer fashion within this inert atmosphere, and where such objects remain in the build unit for extended periods of time, subsequent to a printing process. The present systems and methods increase productivity of the printing process, making transfer between printing and post-processing seamless. Moreover, the methods are inexpensive to deploy and do not involve any addition or modification to existing systems.

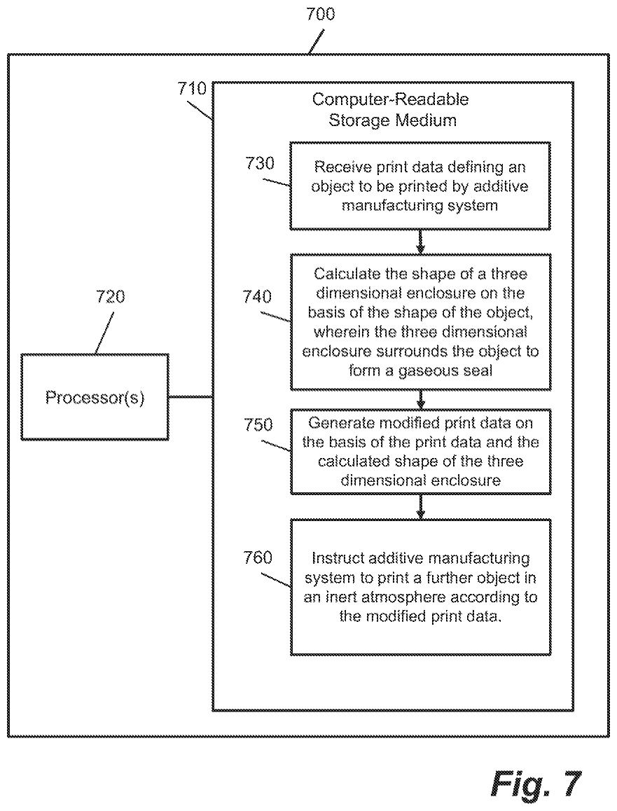

Certain methods and systems as described herein are implemented by one or more processors that processes program code that is retrieved from a non-transitory storage medium. FIG. 7 shows an example 700 of a device comprising a computer-readable storage medium 710 coupled to at least one processor 720. The computer-readable media 710 can be any media that can contain, store, or maintain programs and data for use by or in connection with an instruction execution system. Computer-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc.

In FIG. 7, the computer-readable storage medium comprises program code to: receive print data defining an object to be printed by the additive manufacturing system 730, calculate the shape of a three dimensional enclosure on the basis of the shape of the object, wherein the three dimensional enclosure surrounds the object to form a gaseous seal 740, generate modified print data on the basis of the print data and the calculated shape of the three dimensional enclosure 750, instruct the additive manufacturing system to print a further object in an inert atmosphere according to the print data and modified print data; wherein the further object comprises the object and the three dimensional enclosure 760.

The above examples are to be understood as illustrative. It is to be understood that any feature described in relation to any one example may be used alone, or in combination with other features described, and may also be used in combination with one or more features of any other of the examples, or any combination of any other of the examples. Furthermore, equivalents and modifications not described above may also be employed.

1. A method for use in an additive manufacturing system, the method comprising:
receiving print data defining an object to be printed by the additive manufacturing system; and
causing the additive manufacturing system to print a further object according to modified print data,
wherein the modified print data is generated on the basis of the print data by dynamically determining the shape of a three dimensional enclosure on the basis of the shape of the object, wherein the three dimensional enclosure forms a gaseous seal surrounding the object, and
wherein the further object comprises the object and the three dimensional enclosure.

2. The method of claim 1, wherein the modified print data is generated by the additive manufacturing system.

3. The method of claim 1, wherein the modified print data is generated externally to the additive manufacturing system.

4. The method of claim 1, comprising printing the further object in an inert atmosphere.

5. The method of claim 1, wherein the further object is breakable such that the object is left intact.

6. The method of claim 1, wherein the shape of the three dimensional enclosure is larger than the shape of the object.

7. The method of claim 6, wherein the shape of the three dimensional enclosure is larger than the shape of the object by a minimum threshold.

8. The method of claim 7, wherein the minimum threshold comprises at least one voxel in all dimensions.

9. The method of claim 1, wherein the print data defines two or more objects.

10. The method of claim 9, wherein the three dimensional enclosure sealingly surrounds the two or more objects.

11. The method of claim 9, comprising, for each object of the two or more objects of the print data:
causing the additive manufacturing system to print a further object according to the print data corresponding to the respective object and modified print data generated on the basis of the print data corresponding to the respective object,
wherein the modified print data is generated on the basis of the print data corresponding to the respective object by dynamically determining the shape of a respective three dimensional enclosure on the basis of the shape of the respective object, wherein the respective three dimensional enclosure surrounds the respective object to form a gaseous seal, and
wherein the further object comprises the respective object and the respective three dimensional enclosure.

12. An additive manufacturing system comprising:
a build unit; and
a controller arranged to:
receive print data defining an object to be printed by the additive manufacturing system; and
cause the additive manufacturing system to print a further object in the inert atmosphere according to modified print data
wherein the modified print data is determined on the basis of the print data by dynamically processing the shape of a three dimensional enclosure on the basis of the shape of the object, wherein the three dimensional enclosure surrounds the object in the inert atmosphere, and wherein the further object comprises the object and the three dimensional enclosure

13. The additive manufacturing system of claim 12, wherein the build unit is removable.

14. The additive manufacturing system of claim 12, wherein the enclosure forms a gaseous seal.

15. A non-transitory computer-readable storage medium comprising a set of computer-readable instructions stored thereon, which, when executed by a processor of an additive manufacturing system, cause the processor to:
receive print data defining an object to be printed by the additive manufacturing system;
calculate the shape of a three dimensional enclosure on the basis of the shape of the object, wherein the three dimensional enclosure surrounds the object to form a gaseous seal;
generate modified print data on the basis of the print data and the calculated shape of the three dimensional enclosure; and
instruct the additive manufacturing system to print a further object in an inert atmosphere according to the modified print data,
wherein the further object comprises the object and the three dimensional enclosure.
